(19) United States
(12) Patent Application Publication
(10) Pub. No.: US 2016/0016332 A1
(43) Pub. Date: Jan. 21, 2016

(54) METHOD RELATED TO A SOLID STATE POLYMERIZATION ZONE

(71) Applicant: UOP LLC, Des Plaines, IL (US)

(72) Inventor: Stephan Dietmer Wilhelmi, Bergisch Gladbach (DE)

(21) Appl. No.: 14/335,045

(22) Filed: Jul. 18, 2014

(51) Int. Cl. B29B 9/10; C08J 3/12; C08G 63/183; C08G 63/80

(52) U.S. Cl. CPC B29B 9/10; C08G 63/80; C08J 3/12; C08G 63/183; C08J 2367/02; B29K 2067/00

(57) ABSTRACT

One exemplary embodiment can be a method. The method can include contacting a molten, melt-phase polymerization product with an aqueous liquid, cutting the molten, melt-phase polymerization product while submerged in the aqueous liquid into pellets, expelling the pellets and water at a temperature of at least about 190° C., drying the pellets, and sending the dried pellets to a solid-state polymerization reaction zone.

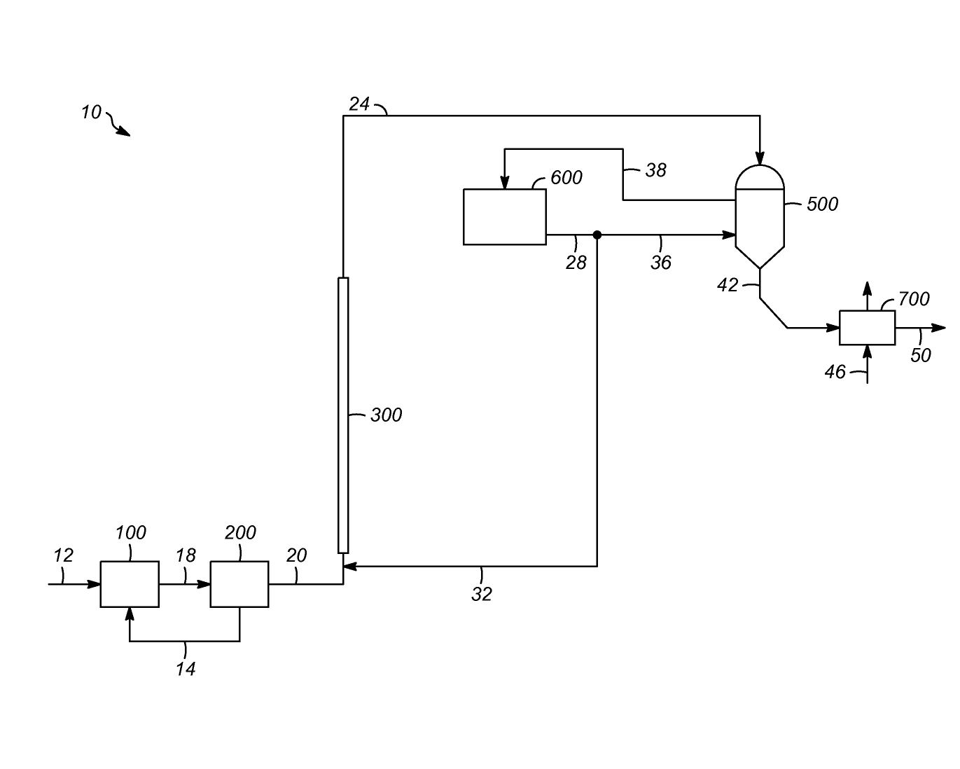

### FIELD OF THE INVENTION

The present invention generally relates to a solid state polymerization zone.

DESCRIPTION OF THE RELATED ART

A polymer resin, and particularly a polyester, may be molded into a variety of useful products. A representative polymer resin having significant commercial applications can include polyethylene terephthalate (PET), polytrimethylene terephthalate (PTT), polybutylene terephthalate (PBT), polytrimethylene naphthalate (PTN), polycyclohexyl terephthalate (PCT) or polyethylene naphthalate (PEN). Of these resins, PET, copolymers of terephthalic acid with lower proportions of isophthalic acid, and PBT are currently widely used in the production of beverage containers, films, fibers, packages, and tire cord.

Commercial processes for manufacturing polyesters typically include four steps: esterification, precondensation, finishing, and solid-state polymerization or solid-state polycondensation (SSP). A melt-phase polymerization (MPP) process for manufacturing PET chips may include the first three of these steps. Typically, the finishing step in MPP continues to upgrade the molten polyester (e.g., PET) to higher molecular weights, appropriate for fiber grades and bottle pre-polymers. During the finishing step, the highly viscous molten polyester may be continuously stirred with a specially-designed agitator to increase its surface area for effective removal of ethylene glycol (EG) and other byproducts by using a very low vacuum or forcing an inert gas through the reaction mixture. Additional upgrading of the MPP product can still be made for some commercial uses. Upgrading is normally achieved in subsequent processing by forming the MPP product into particles and subjecting them to SSP. Molecular weight can be increased in SSP by maintaining the solid polymer particles at temperatures between the glass transition and melting point temperatures, while removing the reaction products under an inert gas sweep or vacuum.

In a typical SSP process, molten polyester resin from the MPP is cooled and then formed into pellets as pre-polymers. This processing can be accomplished by extrusion of the amorphous MPP product into strands under pressure and cutting of the extruded material into smaller particles, followed by rapid quenching. Generally, the pelletizer cuts the polymer strands into pellets in the cutting chamber which is typically completely filled with water immediately after they have passed the die plate.

Because of the high temperature difference between melt temperature and water temperature, the cut polymer drops solidify quickly and shape into a characteristic spherical form, depending on viscosity, of underwater-cut pellets. Generally, the main components of the pelletizer are a cutting chamber with a die plate, a clamping flange, a sight glass, and a support cart. The support cart may include a pelletizer motor, a hydraulic unit, a cutter shaft and a crystallizing device that may crystalize up to 45% of the product. The crystallizing device may dry the product to a very low moisture content, allow the proper dissipation of residual heat and moisture, and prevent the pellets from sticking together and forming clumps.

### SUMMARY OF THE INVENTION

One exemplary embodiment can be a method. The method can include contacting a molten, melt-phase polymerization product with an aqueous liquid, cutting the molten, melt-phase polymerization product while submerged in the aqueous liquid into pellets, expelling the pellets and water at a temperature of at least about 190° C., drying the pellets, and sending the dried pellets to a solid-state polymerization reaction zone.

Another exemplary embodiment may be a method. The method may include expelling pellets and water from an underwater pelletizing zone, drying the pellets, and sending the dried pellets directly to a solid-state polymerization reaction zone.

A further exemplary embodiment can be a method. The method can include contacting a molten, melt-phase polymerization product with an aqueous liquid, cutting the molten, melt-phase polymerization product while submerged in the aqueous liquid into pellets at a residence time of no more than about one second, expelling the pellets and water at a temperature of at least about 200° C., drying the pellets, and sending the dried pellets to a solid-state polymerization reaction zone.

The embodiments disclosed herein can be retrofitted to existing SSP units. Moreover, the embodiments can eliminate process equipment, such as pre-crystallizers, crystallizers, heaters, and one or more surge drums. This elimination of equipment can result in corresponding reductions in capital and operating costs, as it is estimated that an electrical energy saving of up to about 30%, or even up to about 40%, is possible and a heat consumption reduction of up to about 70% is possible. Moreover, nitrogen leakage and dust production can be reduced. Additionally, a smaller PET resin may hasten diffusion and reactivity in an SSP unit, and reduce the size of an SSP reactor of up to about 20%.

### Definitions

As used herein, the term “stream” can include various molecules, such as hydrocarbons, water, and polymerized hydrocarbons in the gas, liquid, and/or solid phases and generally flows when exposed to a pressure differential from a higher pressure to a lower pressure, or when subjected to gravity, i.e., flowing from a higher point to a lower point.

As used herein, the term “zone” can refer to an area including one or more equipment items and/or one or more sub-zones. Equipment items can include one or more reactors or reactor vessels, heaters, separation elements, exchangers, pipes, pumps, compressors, and controllers. Additionally, an equipment item, such as a reactor, dryer, or vessel, can further include one or more zones or sub-zones.

As used herein, the term “resin” can refer to a semisolid or solid complex mix of organic compounds.

As used herein, the term “directly” can refer to communicating a stream without reacting, such as conducting a reaction with at least one other compound, or purifying with a process, such as flashing, distilling, adsorbing, or extracting, to remove, e.g., lighter or heavier compounds. However, a stream can be communicated directly if it undergoes heating or cooling through, e.g., an exchanger.

As used herein, the “percent crystallinity” may be based on the density of a representative sample, or otherwise a representative number of pellets, by its/their buoyancy in a gradient density column according to ASTM D1505-98, “Standard Test Method for the Density of Plastics by Density-Gradient Technique,” assuming density values corresponding to 0% (completely amorphous) and 100% (completely crystalline) crystallinity. In the case of PET, for example, these values are 1.332 g/cc and 1.455 g/cc for, respectively, 0% and 100%. The MPP product, if PET is used, also has an intrinsic viscosity (IV) generally from about 0.50—about 0.70 dl/g which, although adequate for textile or carpet applications, can be significantly increased by advancing its molecular weight for other applications including commercial beverage bottles. The manufacture of major commercial polyester (e.g., PET) end products such as bottles, tire cord, and industrial yarn, can require processing by various techniques such as injection molding, stretched blow molding, and spinning of chips, often having an IV of about 0.70—about 1.2 dl/g.

### BRIEF DESCRIPTION OF THE DRAWING

The FIGURE is a schematic depiction of an exemplary apparatus for solid-state polymerization.

### DETAILED DESCRIPTION

According to an exemplary embodiment depicted in the FIGURE, an apparatus 10 can include an underwater pelletizing or cutting zone 100, a drying zone 200, a hot lift conveyor 300, a solid-state polymerization (SSP) reaction zone 500, a nitrogen purification unit or zone (NPU) 600, and a fluidized bed cooler and a deduster zone 700. Generally, a molten MPP stream 12 is provided at an elevated temperature, and can include a molten MPP product, such as at least one of PET, PTT, PBT, PTN, PCT, and PEN. The molten MPP product can usually be amorphous, or have an average crystallinity of less than about 10%.

In the case of PET resin, the temperature may be in the range of about 230—about 290° C., and is provided to an underwater pelletizing or cutting zone 100, which may include booster pumps and other equipment peripheral to an underwater cutting device, such as an underwater pelletizer.

Usually, representative methods include contacting the molten MPP product, such as a polyester resin, with an aqueous liquid and cutting it into pellets, preferably having shapes that lack edges and thereby resist attrition. A typical underwater pelletizing zone 100, for example, utilizes a cutting chamber that is filled with water or another aqueous liquid (e.g., recycled water having low levels of dissolved and/or suspended contaminants from the MPP product). Often, cutting of the MPP product occurs by contacting it with a hot aqueous liquid (e.g., substantially pure water) having a temperature generally in the range of about 6013 about 90° C. The underwater pelletizers generally cut the MPP product in the aqueous environment immediately upon passing through an extrusion die plate. Due to the high temperature difference between the melt and water, the cut polymer drops can solidify quickly into characteristic spherical or egg-shaped forms characteristic of the underwater cutting operation. The cut pellets typically have a maximum dimension (e.g., diameter of a sphere, major axis of the largest elliptical cross section, or other largest dimension) of about 1— about 5 mm Underwater pelletizing systems are available commercially, for example, from Nordson BKG GmbH (Munster, Germany). The underwater cutting device may produce with respect to, e.g., a PET, a resin of a temperature of about 190—about 210° C., which can correspond to an SSP reaction temperature and impart crystallinity of about 30—about 45% to the molten MPP product and can be provided directly to the SSP reaction zone 500, as hereinafter described. The residence time of the underwater pelletizer or zone 100 can be no more than about one (1) second, or even about one-half (0.5) second. This shortened residence time can elevate the pellets and water stream 18 temperature by about 40° C., or even about 50° C., as compared to longer residence times of three (3) seconds or more. Thus, the expelled pellets and water stream 18 can be at least about 190, about 200, or even about 210° C.

All or most of this hot aqueous liquid is an aqueous recycle liquid stream 14 having a temperature generally in the range of about 60—about 90° C. that can be separated from the dried pellet stream 20 in the drying zone 200, which may include, e.g., a centrifugal drier. A purge stream may be taken from the aqueous recycle liquid stream 14 to limit the accumulation of impurities in the aqueous liquid, in combination with a fresh makeup feed of aqueous liquid (e.g., pure water) to the aqueous recycle liquid stream 14. The expelled pellets and water stream 18 from the underwater cutting zone 100 is therefore fed to the drying zone 200 to carry out this aqueous liquid separation or drying. The recycle loop defined by aqueous recycle liquid stream 14 normally includes associated equipment; generally at least a pump, a filter, and a heater, as well as makeup water and purge streams.

The dried pellet stream 20 can be passed to the hot lift conveyor 300 using any suitable fluid, such as a lift gas stream 32 having nitrogen provided by the NPU 600. Typically, the fluid is heated. The nitrogen can serve as the lift gas for the hot lift conveyor 300. In other exemplary embodiments, a liquid riser, using a fluid such as water, can operate in plug-flow and subsequently utilize a separation vessel, such as a centrifuge. Such a liquid riser is disclosed in, e.g., US 2011/0245452. The dried pellet stream 20 can be considered sent directly to the SSP reaction zone 500 by either passing through or bypassing the hot lift conveyor 300.

A lifted stream 24 from the hot lift conveyor 300 can be sent directly to the SSP reaction zone 500. Both the lift gas stream 32 and an SSP reactor carrier gas stream 36 include portions of a purified nitrogen stream 28 from the NPU 600. The purified nitrogen stream 28 can be used to purge an SSP reactor, and a portion as the carrier gas stream 36 generally contains no water as a result of drying, e.g., using molecular sieve driers. In the case of PET being used as the polyester, the carrier gas stream 36 may enter the SSP reactor at a temperature generally in the range of about 20—about 80° C., and exits as a nitrogen-containing effluent stream 38, containing volatile SSP reaction products such as acetaldehyde, ethylene glycol, and water, at a temperature generally in the range of about 195—about 225° C. In particular, the lift gas stream 32 can include a portion of a nitrogen-containing effluent stream 38 from the SSP reaction zone 500 after removal of organic compounds, namely the portion of gas purified in the NPU 600 and not fed to the SSP reaction zone 500 as the carrier gas stream 36. Usually, organic compounds and water are removed using the NPU 600.

The NPU 600 can remove organic compounds by, e.g., using catalytic combustion in the presence of a precious metal catalyst and water by, e.g., using molecular sieve dryers from the effluent stream 38 from the SSP reaction zone 500. The nitrogen-containing effluent gas, or portion thereof, can be used beneficially for various purposes to include, for example, as the lift gas stream 32. Optionally, heating of the nitrogen-containing effluent gas, or a portion thereof, prior to contacting it with dried pellets can also provide a heating function, for example by preheating the pellets prior to their use in the SSP reactor, in addition to stripping and/or drying functions.

The lifted stream 24 can be provided to the SSP reaction zone 500 optionally after passing from a conveying hopper. Maintaining the dried pellets at elevated temperature advantageously allows their transfer as hot material directly to an SSP reactor typically operating above about 190° C. within the SSP reaction zone 500, thereby avoiding any cool down in the integrated process until after the SSP reactor. The carrier gas stream 36 is provided upward in the SSP reactor. The partially crystallized MPP pellets, in the case of PET, at this point also have an average crystallinity of at least about 30%, and often in the range from about 30—about 45%, and can be suitable for further upgrading, in terms of intrinsic viscosity and molecular weight advancement, in the SSP reactor without becoming sticky above a glass transition temperature. The partially crystallized MPP is also typically in the form of substantially spherical or elliptical cross section pellets or chips having a maximum dimension, for example of about 1—about 5 mm. The average bulk density of the pellets or chips is normally from about 0.8—about 0.9 g/cc.

The purge of moisture generated in the SSP reaction zone 500 and its elimination in the NPU 600 can serve to drive the equilibrium-limited polycondensation reactions in the SSP reaction zone 500 further to completion, as necessary to advance the polymer molecular weight. Usually, the product stream 42 is in the form of chips having an IV of about 0.70—about 1.4 dl/g, suitable for bottle, tire cord, and industrial yarn applications. The hot polyester product, in the form of PET pellets or chips are discharged from the SSP reaction zone 500, generally through further processing equipment such as a fluidized bed cooler and deduster zone 700 to cool and clean the product stream 42 in the presence of a flowing air stream 46 to obtain a cleaned product stream 50 of at least partially crystallized polymer.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A method, comprising:
A) contacting a molten, melt-phase polymerization product with an aqueous liquid;
B) cutting the molten, melt-phase polymerization product while submerged in the aqueous liquid into pellets;
C) expelling the pellets and water at a temperature of at least about 190° C.;
D) drying the pellets; and
E) sending the dried pellets to a solid-state polymerization reaction zone.

2. The method according to claim 1, wherein the cutting of the molten, melt-phase polymerization product occurs at a residence time of no more than about one second.

3. The method according to claim 1, wherein the cutting of the molten, melt-phase polymerization product occurs at a residence time of no more than about one-half second.

4. The method according to claim 1, wherein the temperature is at least about 200° C.

5. The method according to claim 1, wherein the temperature is at least about 210° C.

6. The method according to claim 1, further comprising sending the dried pellets to a hot lift conveyor.

7. The method according to claim 6, wherein the hot lift conveyor uses a heated fluid.

8. The method according to claim 1, wherein the dried pellets are sent directly to a hot lift conveyor.

9. The method according to claim 1, wherein the molten, melt-phase polymerization product comprises at least one of polyethylene terephthalate, polytrimethylene terephthalate, polybutylene terephthalate, polytrimethylene naphthalate, polycyclohexyl terephthalate, and polyethylene naphthalate.

10. The method according to claim 9, wherein the molten, melt-phase polymerization product comprises polyethylene terephthalate.

11. A method, comprising:
A) expelling pellets and water from an underwater pelletizing zone;
B) drying the pellets; and
C) sending the dried pellets directly to a solid-state polymerization reaction zone.

12. The method according to claim 11, further comprising cutting of a molten, melt-phase polymerization product in the underwater pelletizing zone.

13. The method according to claim 12, wherein the cutting occurs at a residence time of no more than about one second.

14. The method according to claim 11, wherein the expelling occurs at a temperature of at least about 200° C.

15. The method according to claim 11, wherein the expelling occurs at a temperature of at least about 210° C.

16. The method according to claim 12, wherein the cutting occurs at a residence time of no more than about one-half second.

17. The method according to claim 11, further comprising sending the dried pellets to a hot lift conveyor prior to the solid-state polymerization reaction zone.

18. The method according to claim 17, wherein the hot lift conveyor uses a heated fluid.

19. A method, comprising:
A) contacting a molten, melt-phase polymerization product with an aqueous liquid;
B) cutting the molten, melt-phase polymerization product while submerged in the aqueous liquid into pellets at a residence time of no more than about one second;
C) expelling the pellets and water at a temperature of at least about 200° C.;
D) drying the pellets; and
E) sending the dried pellets to a solid-state polymerization reaction zone.

20. The method according to claim 19, wherein the molten, melt-phase polymerization product comprises at least one of polyethylene terephthalate, polytrimethylene terephthalate, polybutylene terephthalate, polytrimethylene naphthalate, polycyclohexyl terephthalate, and polyethylene naphthalate.
